(19) United States
(12) Patent Application Publication
(10) Pub. No.: US 2003/0171143 A1
(43) Pub. Date: Sep. 11, 2003

(54) Gaming apparatus and method for playing same

(76) Inventors: John M. Valdez, Pahrump, NV (US); Paul C. Flowers, Las Vegas, NV (US)

Correspondence Address: John M. Valdez, 1450 W. Donner St., Pahrump, NV, 89048, US

(21) Appl. No.: 09/862,661

(22) Filed: May 22, 2001

(51) Int. Cl. G06F 17/00; G06F 19/00; A63F 13/00

(52) U.S. Cl. 463/16; 463/20; 463/22

(57) ABSTRACT

The present invention is Card games that combines the play of Roulette, Keno, Poker and Blackjack with a 3-card deal wager or and prop wager. A table gaming device conceptually similar to a conventional Roulette and 21 table game layout. The present invention comprises, a modified felt layout on a gaming table. Each player places a basic wager and an optional 3-card and prop wager before the cards are dealt. The dealer then deals a card to three specific areas on the table felt in the center of the table face-up. The 3-card winners consists of the 8 numbers in each row on the top of the felt and the prop wagers. The none winning chips are then picked up and the winners are paid by the dealer. The game then continues in a typical fashion. This game provides the dynamics of 3-card game, for enhanced player anticipation and enjoyment.

### FIELD OF THE INVENTION

This invention relates to a gaming apparatus and method of playing the same, and more particularly, to a novel gambling type game which combines element of chance and exercise of judgment also can utilize a Electronic Lighting Device to display the Playing Cards dealt on any particular game on a LED Light Board or other means of display. It is controlled by the means of the use of a Personal Computer interfacing with a Reader/Scanner or Control Box, Power Supply, Circuit Board and a Software Program especially programmed for this game.

### BACKGROUND OF THE INVENTION

Card games are popular games of chance in casinos. A typical card game is played with a (52) fifty-two deck of playing cards without a joker. For example: Twenty-one, Poker or any type of card game may be utilized by this method. However, the casino or house may utilize by adding more decks and may choose to play them out of a device called a shoe, that is placed on the surface of the table or playing felt.

Many known games utilize different kinds of wagering methods for players to be able to wager any amounts of money's they choose in order to be able to make a profit. This game requires the players to bet straight up within three methods with thirty-eight ways of wagering. First method is the “Straight Up Wager” on the first, second and third card dealt wager. On this wager a player must wager on each individual row on as many numbers as they choose, on the card they anticipate will be the first, second and third card dealt on the Playing Area from the number two card to the number nine card. The second method is the “Street Wager”, this wager a player may choose which playing cards they anticipate will be dealt on any one of the three cards dealt from the number two through the number nine card. For example if a player chooses the “Street Bet 9” and any one of the three cards dealt is a nine a player would win that wager. The third method is the proposition bets or high stakes wager, these wagers are won by the combination of the two to three cards dealt in a certain order or certain ways, in-order to win on this wagers. The proposition bets are as follows, “Any Pairs”, “3 Tens or Higher”, “Any Flush”, “Any Straight”, “3 of A Kind” and “Three to the Royal”. This pay out odds involved doesn't require the players to exercise a high degree of judgment. Complex rules are not involved and a complex system does not need to be utilized by the players or dealer.

This game will bring out excitement in a player, with the thirty-eight different possibility of winning in every game, this is because of the three cards being dealt per hand, which in turn means each card would count as a winning way(s) per game. Another special addition to the game is the high pay out odds that are included in some of the wagering possibilities.

The layout of the game is also unique because there are two betting areas on the layout, but the mirror image of each other. The betting area on one side is designed for three players that are seated to the same side of that table. The other betting area is just opposite of the table is for the other three players on the opposite side of that table. This avoids chips to be cluttered in any one betting square and color coded chip do not have to be utilized by the house as in the game of Roulette.

The deck of cards that is used in this particular game uses six regular decks of cards without a joker and a shoe that the cards are dealt from.

The light board is a unique method that player can see which cards and suit have been played each game. The light board will be controlled by either the dealer sliding each card that is

The light board display is a unique method that player can see which cards and suit have been played in each came. The light board will be controlled by either the dealer sliding each card that is being played through a slot type casing (Playing Card Reader/Scanner) that is placed just in front of the Cheque rack. This in turn would be connected to a microprocessor, CPU, Circuit Board and controlled by a special programmed designed for this game, that is than inputted to the LED light board or any other type of display method. This Light Board will be standing upward about one foot from the table with a pole for every player to watch which cards have already been dealt in previous games. Or by the dealer using a control box that will be place next to the Cheque rack and controlled by a CPU unit, program and circuit board under each table. But the game may also be played without this electronic method.

### SUMMARY OF THE INVENTION

The present invention is a card layout gaming device that can be used or played in a casino or gaming establishment where gambling is permitted. The present invention comprises a felt layout, any color, having drawings on its service of a plurality of numbered areas, worded areas, squares, rectangles and circles. There will also be a square with a circle and number within, there are six, one for each player, this will show each player where they are required to place their bet on each given wager on the designated area on the layout on their side of the betting area.

Each game will also have a Cheque Rack with approximately twelve to fifteen tubes, a paddle, drop box, and padded rails, that will be located within a regular Twenty-one type table. That the Triple Chance felt will be fitted over. There will also be a card discard rack, a card shoe, six decks of playing cards with out jokers. If played with the electrical system, their will also be a Playing Card Reader/Scanner or a Control Box connected to a CPU interface, circuit board, microprocessor, that will be fitted under the table and a light board or any other display type board, standing straight up on top of the table, held up by a one to two inch diameter pole.

It is the foregoing object of the invention and other features to have the minimum of three methods of winning per game but thirty-eight possibilities so the players may enjoy more play for their money and for the game to be a player friendly game.

The betting areas are designed for players to be able to bet with the chance that a certain card or combination of cards that will be drawn from the deck/shoe. That in turn makes the game more fun and exciting for all players to be able to try to guess which card or combination of cards they believe will be dealt in any game.

Furthermore, it is the object of the invention to effectively provide a game with a general type of betting or wagering system. Which is unique by players being able to bet or wager on the same wagers and not on their own hand, but they may participate with each other to try to effectively choose the winning wagers or combination of cards they fell will be dealt by the dealer.

As well as the method of a player being able to see what cards were dealt in the previous games. Through the means of the lighting system displaying each game played and posting the last twelve games played, on the LED light board or other light board methods that can be utilized. Giving the players more latitude and excitement in guessing the out come on the next three cards that will be played.

### BRIEF DESCRIPTION OF THE DRAWINGS

The invention is illustrated and directed to a table game with means of chance that can be played by one to six players against the casino or house. The accompanying drawings that form a part of this application are as follows:

FIG. 1 is a perceptive illustration embodiment of top view of layout, illustrating a plurality of the outer areas of the game/layout. The Players Betting or Wagering Area, Card Placement Area, Players Area, Dealer Area, Card Discard Rack, Control Box, Light Board, Playing Card Reader/Scanner and the Cheque Rack Area.

FIG. 2 is a perceptive illustration embodiment of the top view of the Betting or Wagering Area rectangular area having drawings of numbered and worded areas within three rows numbered from 2 through 9, First Card row winning numbers, next over is the Second Card row, and the Third Card row, illustrating a plurality of the inner areas of the Betting/Wagering Area.

FIG. 3 is the illustration drawings of the is the Prop Betting area, are five wagers in this area, the first starting from the right hand side is the Any Pair Pays 3 to 1, next over to the left is the Any Flush Pays 15 to 1, next over is the Any 3 Cards 10's and Up Pays 16 to 1, next over is the 3 of A Kind Pays 180 to 1 and finally far left is the Any 3 To The Royal Pays 550 to 1.

FIG. 4 is the illustration drawings of the Light Board Display on the front side of the Light Board, there is a LDS screen there are three rows the first shows the First Card dealt screen and the Second row is the Second Card dealt screen and the third row is the Third Card screen with the last fifteen games played.

FIG. 5 is the illustration drawings is the Control Box that has 20 labeled buttons marked 2, 3, 4, 5, 6, 7, 8, 9, 10, J, Q, K, A, C for Clear, E for Erase, R for Restart, a heart symbol, a club symbol, a spade symbol, a diamond symbol.

FIG. 6 is the illustration drawing of the diagrams of the Electrical System that includes the Playing Card Reader/Scanner, Circuit Board, Light Board, Control Box, Power Supply and CPU.

FIG. 7 is the Electrical and Lighting Diagram of the game.

FIG. 8 is the method of CPU unit interfacing with the Reader/Scanner and Lighting System.

FIG. 9 is the calculations, probability, odds, suggested pay out and suggested hold for the house and players.

FIG. 10 is the playing pieces that will be used to play the game is the Dealers Shoe and the Cheque and the Playing Cards these are the components that are used in playing the game.

### DESCRIPTION OF THE PREFERRED EMBODIMENT

The gaming device shown in:

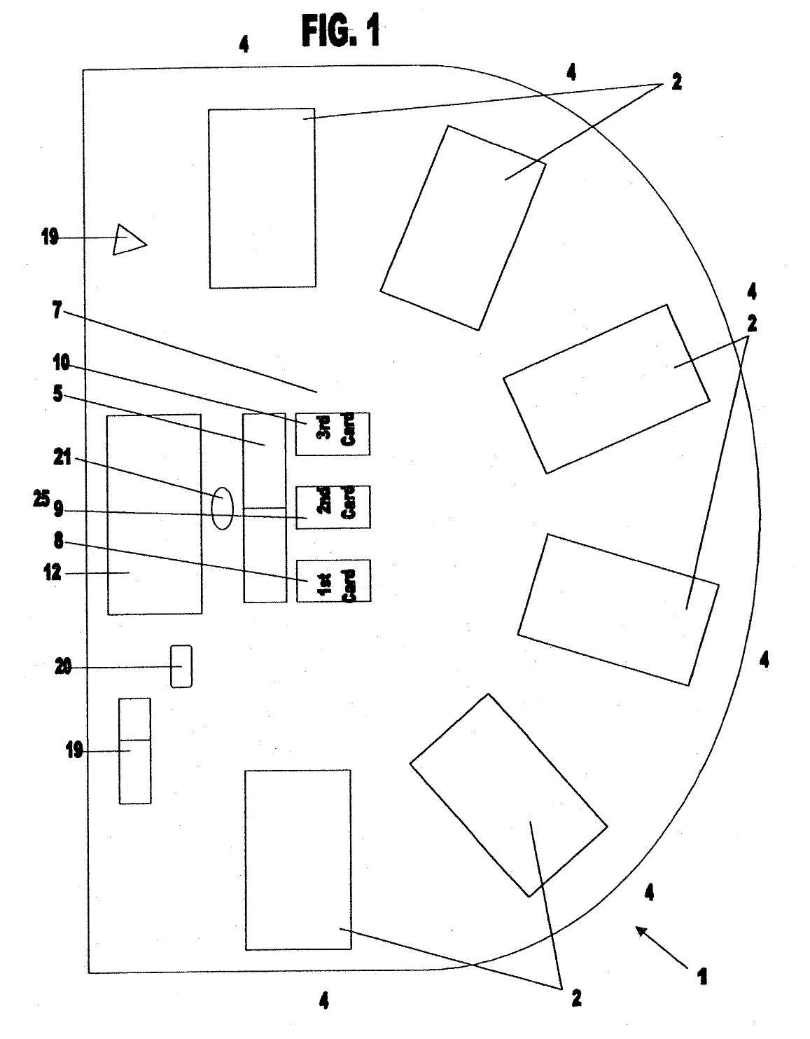

FIG. 1. is a perceptive illustration embodiment of the top view of the layout 1, illustrating a plurality of players Betting or Wagering Area 2 rectangular area having drawings of numbered and worded areas within three rows 3 that are set on the front of each players area 4 within a large rectangular area 2 numbered from 2 through 9 and also a prop-bet area 5 just above the Cheques area 6 The Dealer Area 26 is where the dealer stands and controls the game and just in-front of the Place Card Area 7, comprising of thrifty-two wagered areas within the wagering area 2 also on the layout 1 is three areas 7 that the regular poker playing cards are place on every game, the first is the 1st card area 8 and next is 2nd card area 9 then the 3rd card area 10, the next object on the layout is the Card Discard Rack 19 and the Control Box 20 and the Reader/Scanner 21 and the Light Board 22. The Control Box 20 and the Reader/Scanner 21 is what the dealer uses to control the Electrical System 41. The Card Discard Rack 19 is were the cards that are no longer in play will be placed. The Dealer Area 25 is where the dealer stands and controls the game.

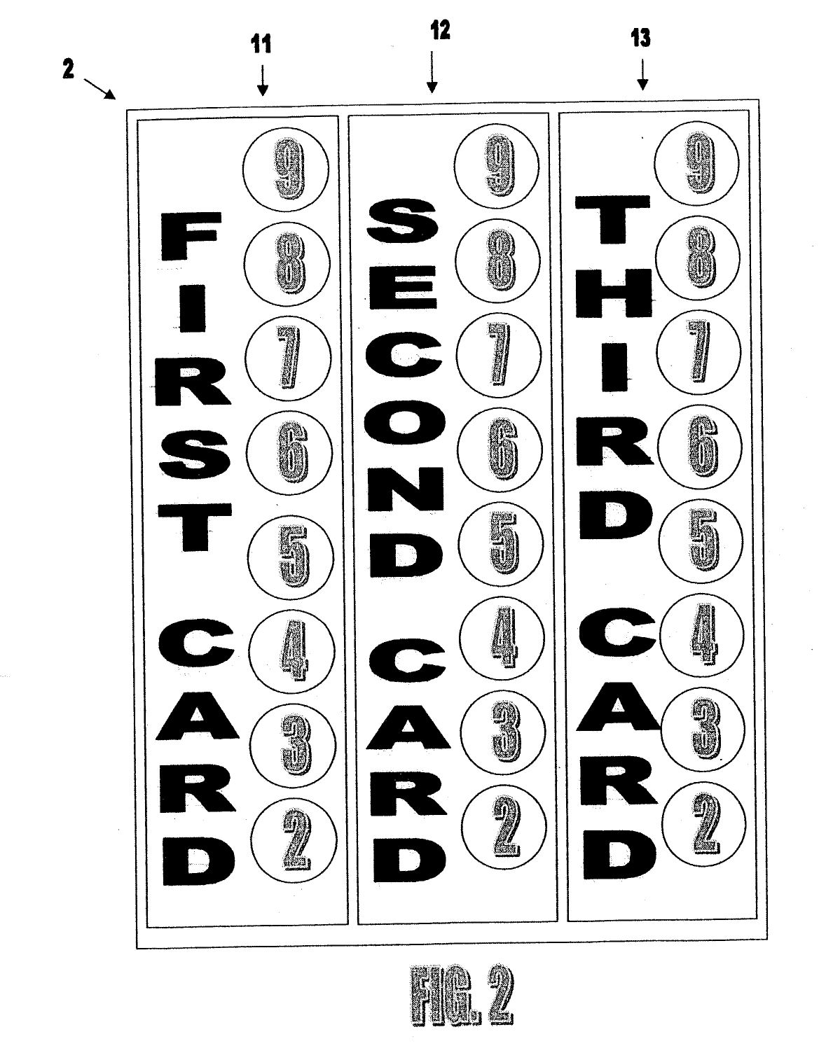

FIG. 2. is the Betting or Wagering Area 2 rectangular area having drawings of numbered and worded areas within three rows 3 numbered from 2 through 9, First Card row 11 winning numbers is determined by the card dealt in the 1st card area 8, the next over is the Second Card row 12 winning number is determined by the 2nd card area 9 and the Third Card row 13 winning number is determined by the 3rd card area 10.

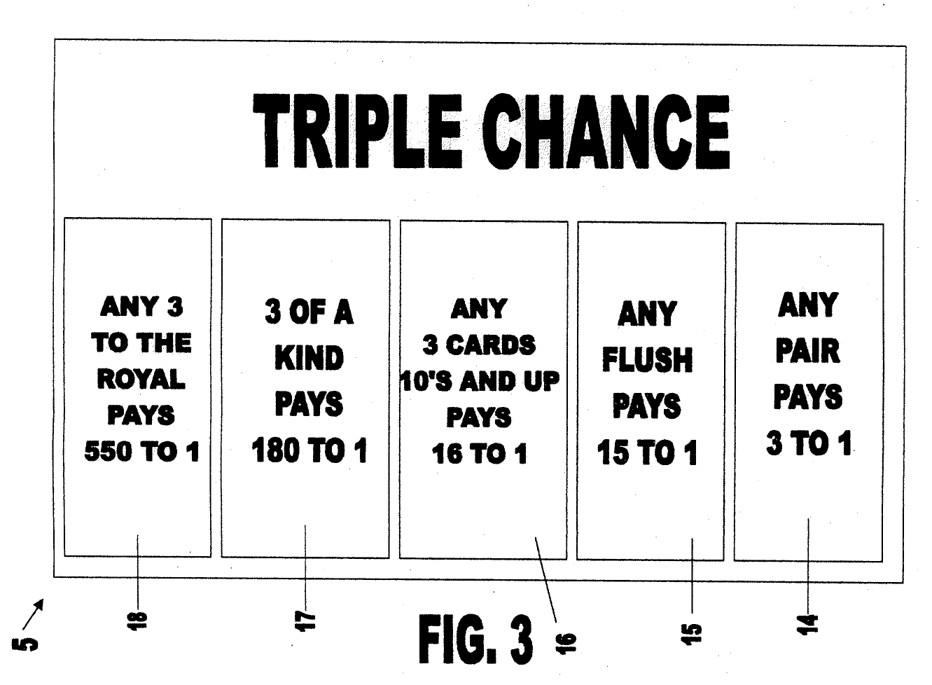

FIG. 3. is the Prop Betting area 5 that is laid out just below the Cheque area 6, there are five wagers in this area, the first starting from the right hand side is the Any Pair Pays 3 to 1 14, next over to the left is the Any Flush Pays 15 to 1 15, next over is the Any 3 Cards 10's and Up Pays 16 to 1 16, next over is the 3 of A Kind Pays 180 to 1 17 and finally far left is the Any 3 To The Royal Pays 550 to 1 18.

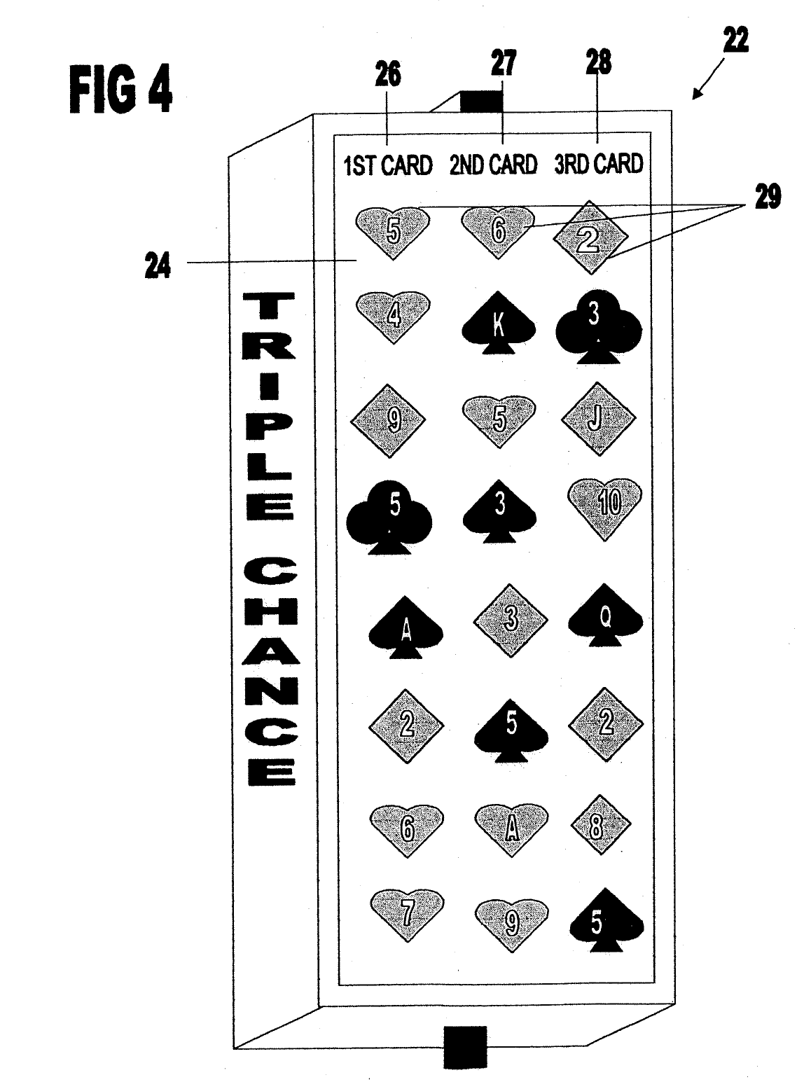

FIG. 4. is the Light Board 22, this is a box that stands in one corner of the table layout 1 on the front side of the Light Board 22 there is a LDS screen 24 there are three rows the first shows the First Card Dealt screen 26 and the second row is the Second Card dealt screen 27 and the third row is the Third Card screen 28 with the last fifteen games played 29.

FIG. 5. is the Control Box 20 that has 20 labeled buttons marked 2-51, 3-52, 4-53, 5-54, 6-55, 7-56, 8-57, 9-58, 10-59, J-60, Q-61, K-62, A-63, C-64, E-65, R-66, A heart symbol 67, A club symbol 68, A spade symbol 69, A diamond symbol.

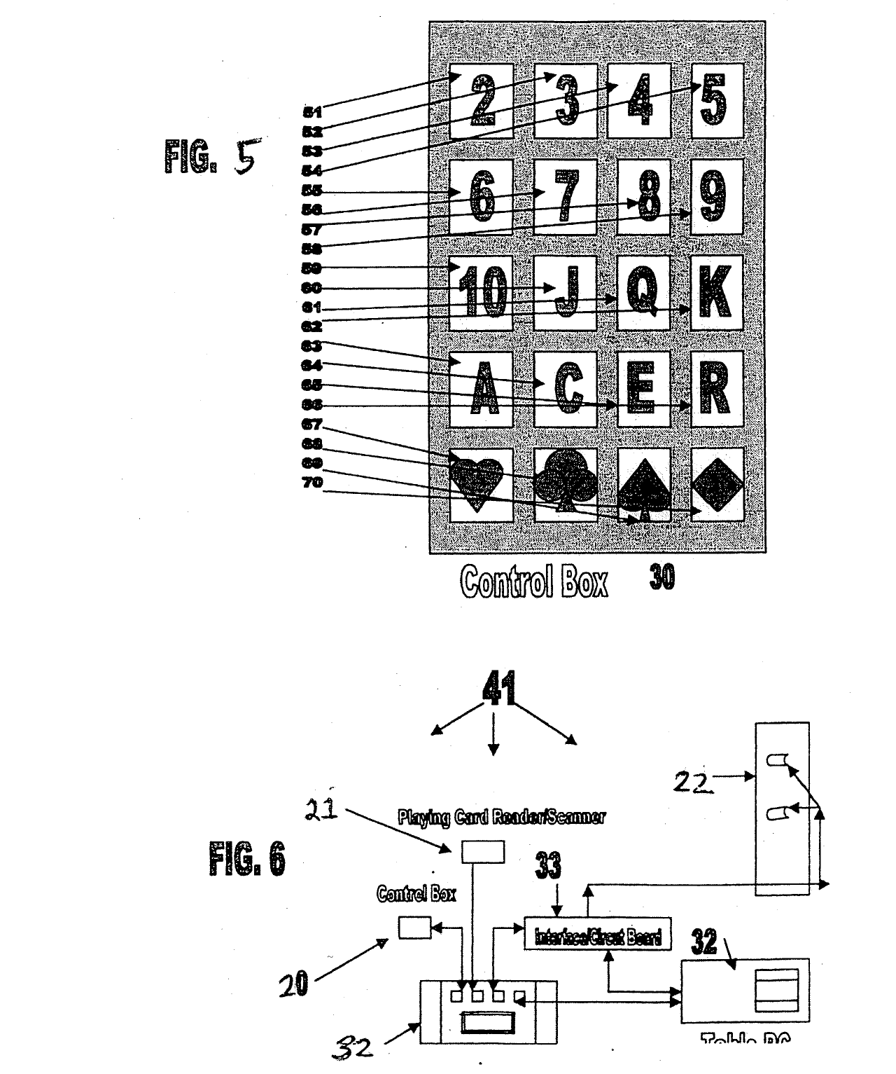

FIG. 6. consists of illustration drawing of the diagrams of the Electrical System 41, Playing Card Reader/Scanner 21, Interface/Circuit Board 33, Light Board 22, Control Box 20 Power Supply 43 and Table CPU 32.

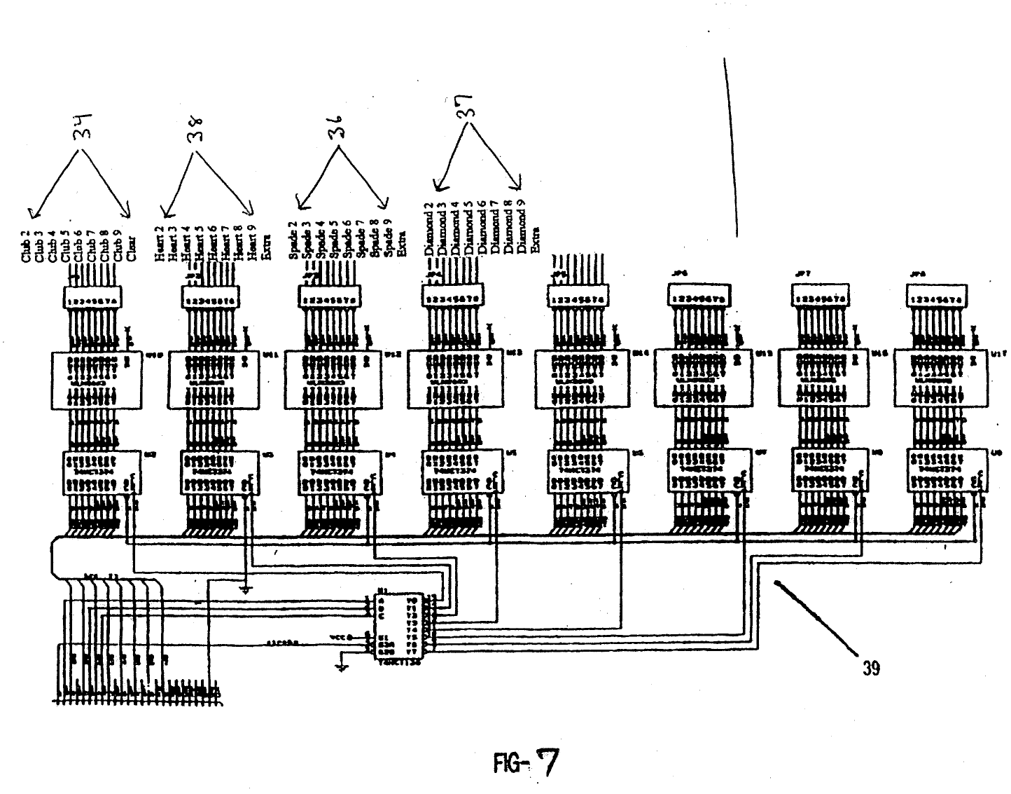

FIG. 7 is the lighting diagram 39 and the method used for running the Electrical System 41 through the program 49 their are a Club lights 2 through 9 and a extra 34, Heart lights 2 through 9 and a extra 38, Spade lights 2 through 9 and a extra 36, Diamond lights 2 through 9 and a extra 37.

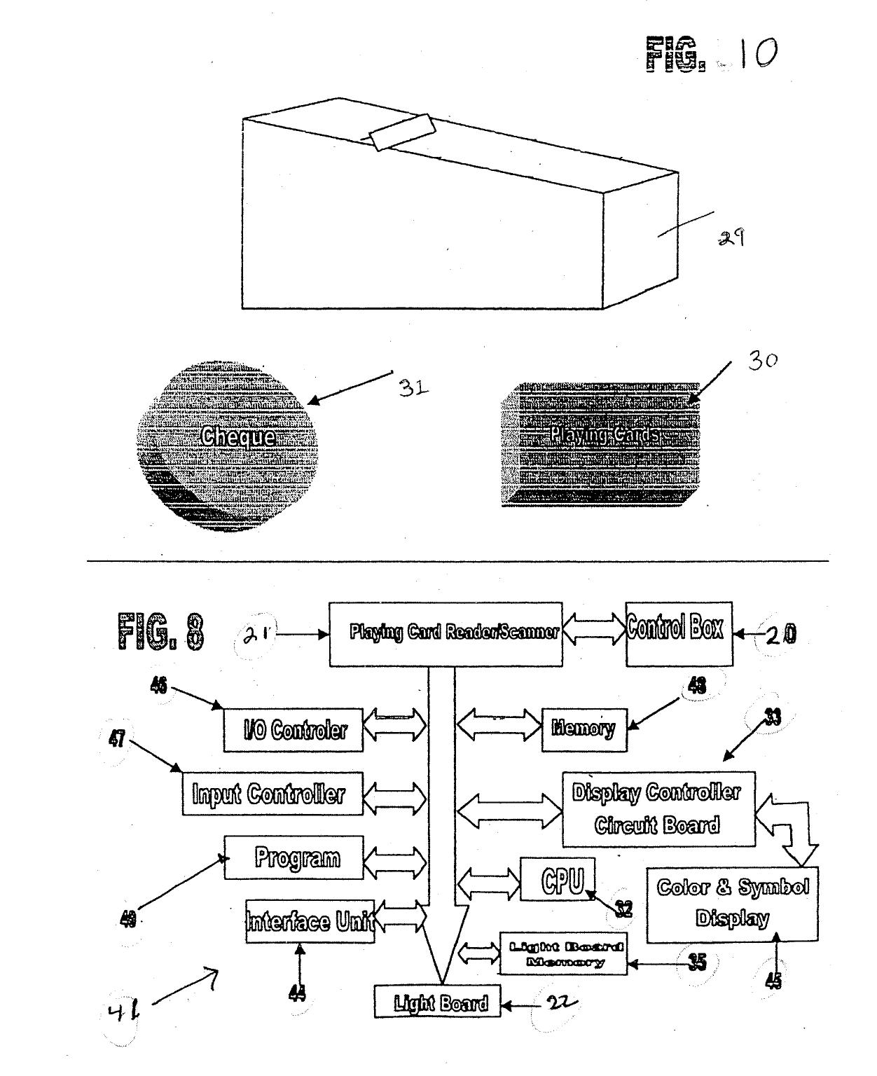

FIG. 8. is the lighting diagram 39 and the method used for running the Electrical System 41 by the playing card being screened through the Playing card Reader/Scanner 21 or Control Box 20 in turn flows to the Memory System 48 and to the I/O Control 46. Then through the Input Controller 47, also through the Display Controller Circuit Board 33 and Color & Symbol Display 45. Then through the on through the CPU 32 and Program 49. On through the Interface Unit 44 to the destination of the Memory System 35 and to the final destination the Light Board 22.

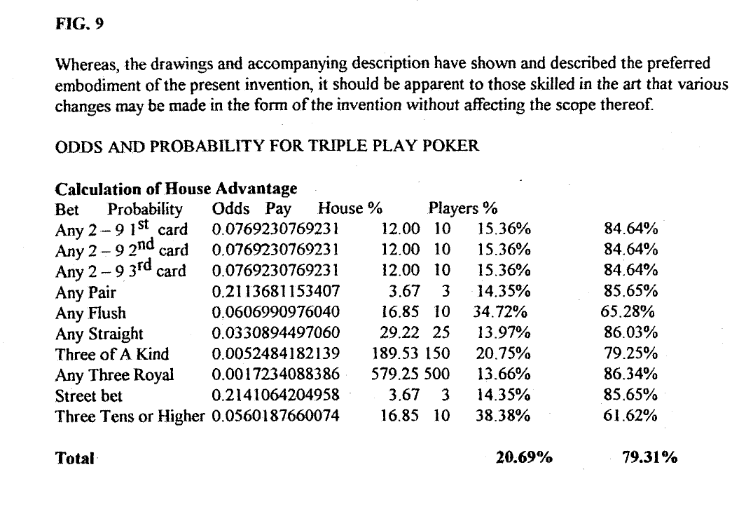

FIG. 9. is the calculations, probability, odds, suggested pay out and suggested hold for the house and players.

FIG. 10. is the Dealers Shoe 29 and the Cheque 31 and the Playing Cards 30 these are the components that are used in playing the game.

To begin the play of each game, the dealer will shuffle all six decks of cards and place them in the Shoe 29. The dealer then has a player cut the deck(s) of Playing Cards 21 with a green card marker and that series of games will be played till that marker is reached and the six decks will then have to be reshuffled once again. Each player is provided with a Player Area 4, and can exchange dollar denominations for Cheques 31 for the equal value. Each player places their Cheque 31 on their desire square(s) or Rectangle(s) on the Betting Area 2 (as shown in FIG. 1), as many as the casino or house will limit. Players may wager on the same square(s) or rectangle(s) if they so desire, but only as shown on the Player Area 4. The dealer then shoots to the player(s), “NO MORE BETS”. Next the dealer slides out the first Playing Card 30 from the Shoe 29 and burns/discards it and places it in the Card Discard Area 19 that is also located on top of the felt next to the Cheque Rack 6.

Next the dealer slides out the next Playing Card 30 from the Shoe 29 and slides it through the Playing Card Reader/Scanner 21 and places it face up on the square marked First Card 8 in the Place Card Area 7 center of the Betting Area 2. Then proceeds to slide out the next Playing Card 30 from the Shoe 29, and burns/discards that Playing Card 30 and places it on the Discard Area 19. Then proceeds to slide out the next Playing Card 30 from the Shoe 29 and slides it through the Playing Card Reader/Scanner 21 and places it on the square marked Second Card 9 in the Place Card Area 7. Then proceeds to slide out the next Playing Card 30 from the Shoe 29 and burns/discards that Playing Card 30, and place it on the Discard Area 19. Then proceeds to slide out the third and final Playing Card 30 of that game from the Shoe 29 and slides it through the Playing Card Reader/Scanner 21 and places it on the square marked Third Card 10 in the Place Card Area 7. Then presses the button on top of the Playing Card Reader/Scanner 21, that in turn lights up the three cards on the Light Board 22. If using the Electrical System 41. If using the Control Box 20. The dealer slides out the first Playing Card 30 from the Shoe 29 and burns/discards it and places it in the Card Discard Area 19 that is also located on top of the felt next to the Cheque Rack 6.

Next the dealer slides out the next Playing Card 30 from the Shoe 29 and would press the button on the Control Box 20 that corresponds with that Playing Card 30 and places it face up on the square marked First Card 8 in the Place Card Area 7 center of the Betting Area 2. Then proceeds to slide out the next Playing Card 30 from the Shoe 29, and burns/discards that Playing Card 30 and places it on the Discard Area 19. Then proceeds to slide out the next Playing Card 30 from the Shoe 29 and would press the button on the Control Box 20 that corresponds with that Playing Card 30 and places it face up on square marked Second Card 9 in the Place Card Area 7. Then proceeds to slide out the next Playing Card 30 from the Shoe 29 and burns/discards that Playing Card 30, and place it on the Discard Area 19. Then proceeds to slide out the final Playing Card 30 of that game from the Shoe 29 and would press the button on the Control Box 20 that corresponds with that Playing Card 30 and places it face up on the square marked Third Card 10 in the Place Card Area 7. Then presses the button E for Enter 65 on the Control Box 20, that in turn lights up the three cards on the Light Board 22.

The dealer then removes all Cheques 31 from the Betting Area 2 that were not winning wagers. Places them in the Cheque Rack 6 located in front of the Dealer Area 25 and begins to pay out the winning bets that remained on the Betting Area 2. When all bets are paid out the dealer then removes the three Playing Cards 30 from the Place Card Area 7 that where dealt and places them in the Card Discard Area 19 and shouts out “next game” “bets in” and another game begins.

What is claimed is:

1. A gaming apparatus comprising:
a. a gaming devise with a plurality of numbers, words, squares and rectangles in a pre-selected pattern with a predetermined pattern of words and numbers;
b. a Playing Card Reader/Scanner in electrical communication with the microcomputer, (when not using the Control Box or playing the game with out the electrical system) located just between the Cheque Rack and Betting Area;
c. a Control Box in electrical communication with the microcomputer, with approximately 20 buttons each controlling a certain command (when not using the Playing Card Reader/Scanner or playing the game with out the electrical system);
d. a microcomputer system proximately located under the table;
e. a means for displaying game information (the face value and suit of each playing card dealt in the First, Second and Third Card Area for each game played) through a Light Board display standing on an upright position on top of the table held up by a two to three inch pole;
f. a means for light control the means for light control being in electrical communication with the microcomputer and the first plurality of lights;
g. a betting distribution area integrally formed on a cloth type felt and placed the table top of a twenty one table, the betting distribution area having a first plurality of labeled spaces, the two mirror images on both sides of the layout, with the center where the playing cards will be placed;
h. a special program designed for the purpose of lighting up a plurality of the symbols/suits and face value of a regular deck of playing cards in the electrical communication with the microcomputer and light board;
i. a special lighting diagram for the light board display unit;
j. a calculated, probability, odds, pay out, player and house holds;
k. playing the game with out an electrical system;
l. also playing game method through a real type or screen version;
m. playing same method of play through a home version type board game; and
n. Rules and instructions for playing the game.

2. The gaming apparatus of claim 1, wherein each square and rectangle in the predetermined pattern of numbers and words is marked in three rows First Row 11, Second Row 12 and Third Row 13, closest to the player area with six “9”s, six “8”s, six “7”s, six “6”s, six “5”s, six “4”s, six “3”s and six “2”s; the Proposition Bets Row 5, there are Any Pair Pays 3 to 1-14, next over to the left is the Any Flush Pays 15 to 1-15, next over is the Any 3 Cards 10's and Up Pays 16 to 1-16, next over is the 3 of A Kind Pays 180 to 1-17 and finally far left is the Any 3 To The Royal Pays 550 to 1-18.

3. The gaming apparatus of claim 2, wherein the computer system is in electrical communication with the Playing Card Reader/Scanner 21.

4. The gaining apparatus of claim 3, wherein the microcomputer is in electrical communication with a plurality of remotely located microcomputer.

5. The gaming apparatus of claim 1, wherein the betting distribution area comprises five horizontal rows with the two side mirror images of each other with the center is where the cards in play will be dealt face up and on the top of that in the fifth row is were all six players would place their bet for the Three to the Royal propitiation bet as well.

6. The gaming apparatus of claim 4, wherein the means for displaying game information further comprises a light board unit to display the card face value and symbol/suit of each playing card dealt in the First, Second and Third Card Area for each game played.

7. The gaming apparatus of claim 5, wherein the Control Box is in electrical communication with the microcomputer, and has 20 individual buttons each controlling a certain command in conjunction with the electrical system and the cards being dealt.

8. The gaming apparatus of claim 4, further includes the Light Board display unit displaying up to twelve individual games through the means of a LED unit or other type of lighted board showing the face and the suit of each card that was dealt in certain games through the use of the electrical system and microcomputer.

9. The gaming apparatus of claim 6, wherein the light control being in electrical communication with the microcomputer and the plurality of lights through the means of a LED system or other type of displaying suits and face value of the playing cards on each individual game.

10. The gaming apparatus of claim 7, wherein the layout will be manufactured of a cloth type Felt and the numbers, words, squares and rectangles will be silk screen printed on. But is using a board game will be on a card board material with a four-color process.

11. The gaming apparatus of claim 8, wherein a special program is written for the control of the electrical system for the control of the memory, lighting system and microprocessor.

12. The gaming apparatus of claim 9, wherein a special lighting diagram is made to direct which Pattern of numbers, letters or suits will be displayed on the light board.

13. The gaming apparatus of claim 10, wherein the mathematical calculation, probability and odds have been determined for the game.

14. The gaming apparatus of claim 11, wherein that this game can be adapted also in the same method unto a touch screen or slot reel type using the same rules and math.

15. The gaming apparatus of claim 12, wherein that this game can be adapted also in the same method unto a board game version using the same rules and math.

16. The gaming apparatus of claim 13, wherein can be played without the use of the electrical system and by the players and dealer just playing by the rules and math of the game.

17. The gaming apparatus of claim 14, wherein special rules and instruction in the playing method of the game.
